(19) United States
(12) Patent Application Publication
(10) Pub. No.: US 2026/0246215 A1
(43) Pub. Date: Aug. 20, 2026

(54) ELECTRICAL CONNECTOR ASSEMBLY

(71) Applicant: EZCONN CORPORATION, New Taipei City (TW)

(72) Inventor: Chang-Jie Tsau, New Taipei City (TW)

(21) Appl. No.: 19/541,977

(22) Filed: Feb. 17, 2026

Related U.S. Application Data
(60) Provisional application No. 63/758,562, filed on Feb. 14, 2025.

(51) Int. Cl. H01R 24/50; H01R 12/75; H01R 13/26; H01R 13/512; H01R 13/6591; H01R 24/52; H01R 103/00

(52) U.S. Cl. CPC H01R 24/50; H01R 12/75; H01R 13/26; H01R 13/512; H01R 13/65914; H01R 24/52; H01R 2103/00

(57) ABSTRACT

An electrical connector assembly, adapted for an amplifier, including a circuit board, having a transmission circuit; a first electrical connector, disposed on the circuit board and comprising a first joint and a first terminal, wherein the first terminal is disposed in the first joint; and a second electrical connector, disposed on the circuit board and comprising a second joint and a second terminal, wherein the second terminal is disposed in the second joint, and the first terminal is electrically connected to the second terminal via the transmission circuit.

### FIELD

The present disclosure generally relates to an electrical connector assembly.

### BACKGROUND

Various types of electrical connectors have been developed. However, an improved electrical connector would be welcomed in the technology.

### SUMMARY

Aspects and advantages of the technology will be set forth in part in the following description, or may be obvious from the description, or may be learned through practice of the technology.

In one aspect, the present subject matter is directed to an electrical connector assembly, adapted for an amplifier, including a circuit board, having a transmission circuit; a first electrical connector, disposed on the circuit board and comprising a first joint and a first terminal, wherein the first terminal is disposed in the first joint; and a second electrical connector, disposed on the circuit board and comprising a second joint and a second terminal, wherein the second terminal is disposed in the second joint, and the first terminal is electrically connected to the second terminal via the transmission circuit.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an electrical connector in accordance with aspects of the present subject matter;

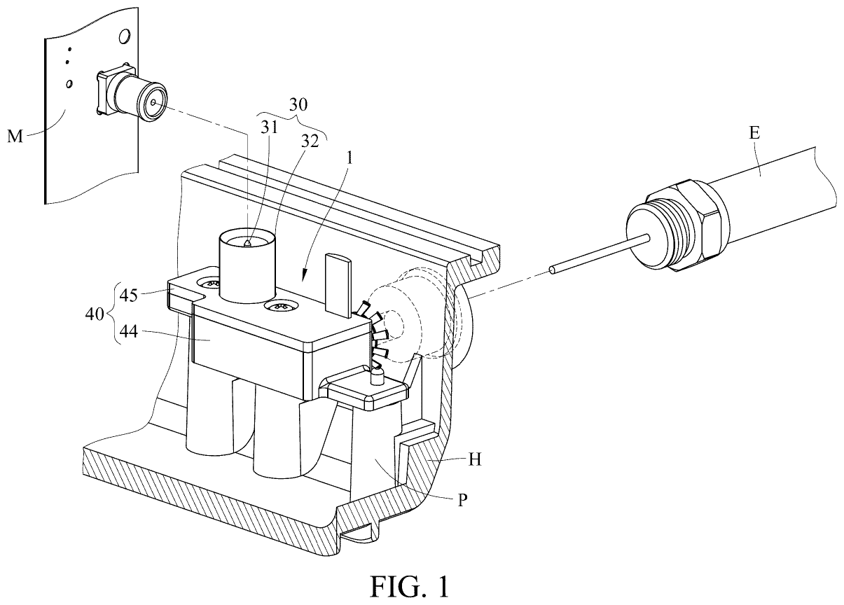

FIG. 2 illustrates an exploded view of an electrical connector in accordance with aspects of the present subject matter;

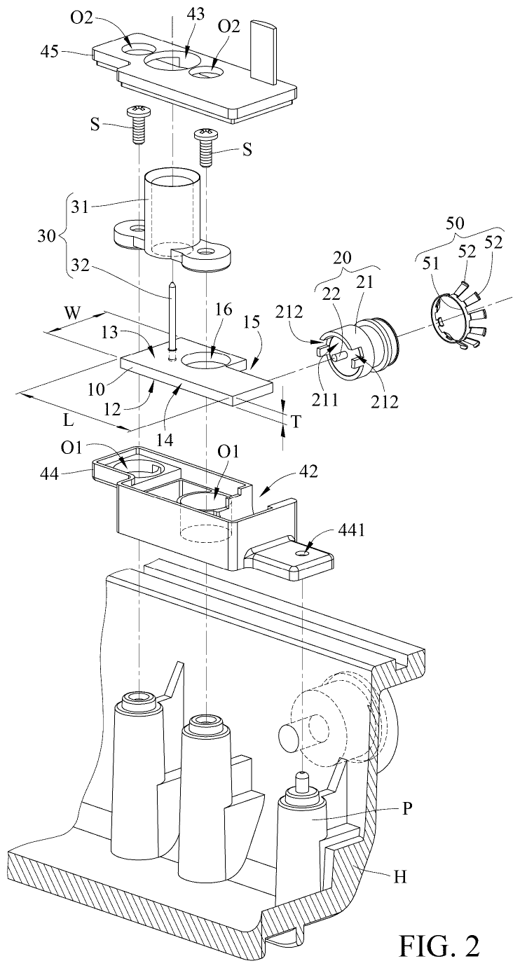

FIG. 3 illustrates another exploded view of an electrical connector in accordance with aspects of the present subject matter; and

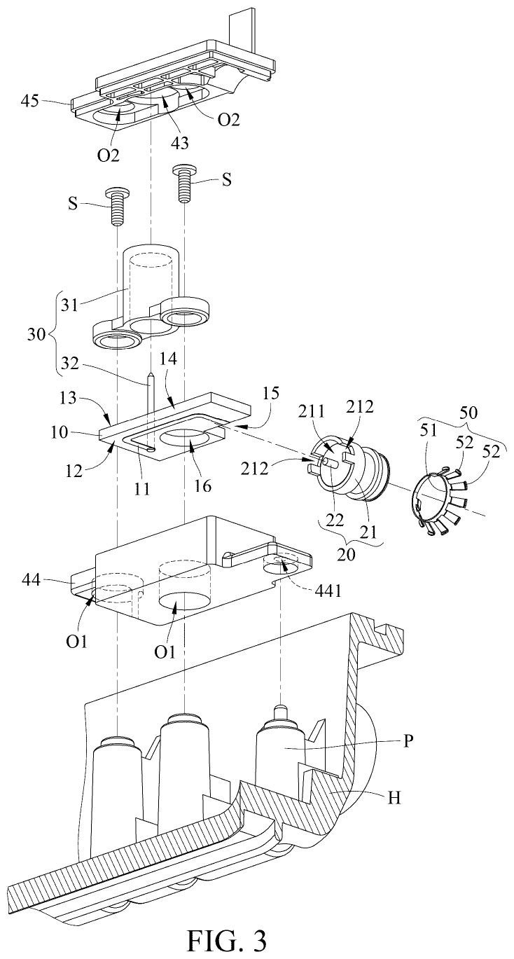

FIG. 4 illustrates a cross-sectional view of an electrical connector in accordance with aspects of the present subject matter.

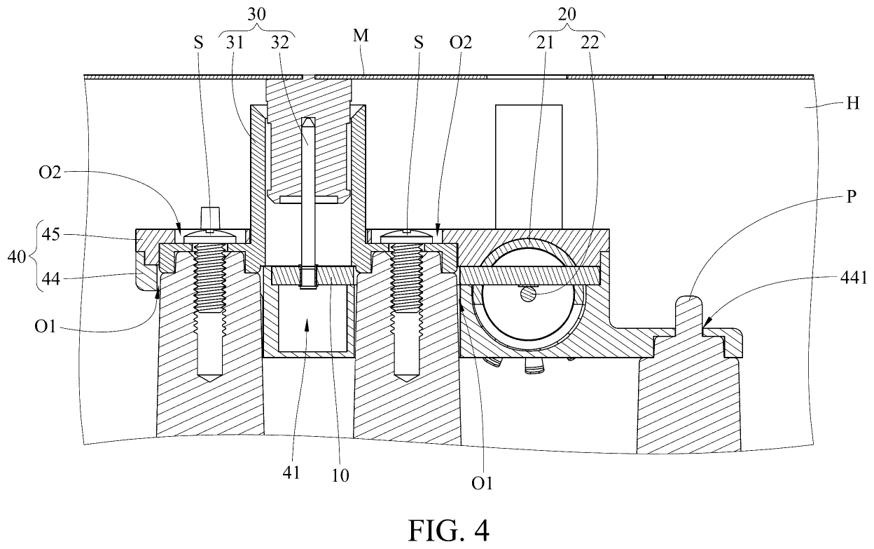

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

An electrical connector assembly (1), adapted for an amplifier, including: a circuit board (10), having a transmission circuit (11); a first electrical connector (20), disposed on the circuit board and comprising a first joint (21) and a first terminal (22), wherein the first terminal is disposed in the first joint; and a second electrical connector (30), disposed on the circuit board and comprising a second joint (31) and a second terminal (32), wherein the second terminal is disposed in the second joint, and the first terminal is electrically connected to the second terminal via the transmission circuit.

The electrical connector assembly according to one or more aspects of the above subject matter, wherein the first electrical connector and the second electrical connector are radio frequency coaxial connectors (e.g., a F-type connector and a G-type connector).

The electrical connector assembly according to one or more aspects of the above subject matter, wherein the circuit board has a first surface (12), a second surface (13) and a side surface (14), the first surface and the second surface face away from each other, the side surface is connected to the first surface and the second surface, the transmission circuit is located at the first surface, the first joint of the first electrical connector is disposed on the side surface of the circuit board, the first terminal is in electrical contact with the transmission circuit on the first surface of the circuit board, the second joint of the second electrical connector is disposed on the second surface of the circuit board, the second terminal penetrates through the circuit board from the second surface of the circuit board and reaches the first surface to be in electrical contact with the transmission circuit.

The electrical connector assembly according to one or more aspects of the above subject matter, wherein the first joint has an interior space (211) and two mount recesses (212), the first terminal is located in the interior space, the two mount recesses are respectively located two opposite sides of the interior space, and the circuit board is engaged with the two mount recesses and is partially located in the interior space.

The electrical connector assembly according to one or more aspects of the above subject matter, wherein the circuit board has a notch (15) located at one corner of the circuit board, and the first electrical connector is located in the notch of the circuit board.

The electrical connector assembly according to one or more aspects of the above subject matter, wherein a length (L) of the circuit board is not less than 15 mm and not greater than 60 mm, a width (W) of the circuit board is not less than 10 mm and not greater than 40 mm, and a thickness (T) of the circuit board is not less than 1 mm and not greater than 5 mm.

The electrical connector assembly according to one or more aspects of the above subject matter, further comprising a casing 40), wherein the casing has an accommodation space (41), a first through hole (42) and a second through hole (43), the first through hole and the second through hole communicate with the accommodation space, the circuit board is disposed in the accommodation space of the casing, and the first joint and the second joint respectively penetrate through the first through hole and the second through hole.

The electrical connector assembly according to one or more aspects of the above subject matter, wherein the casing comprises a base (44) and a cover (45) assembled with each other, the base and the cover together form the accommodation space, the base has two first openings (O1) communicating with the accommodation space, the cover has two second openings (O2) communicating with the accommodation space, the two first openings are respectively aligned with the two second openings, the two first openings and the second openings are respectively configured for two screws (S) to penetrate therethrough, such that the two screws fix the casing to a housing (H) of the amplifier.

The electrical connector assembly according to one or more aspects of the above subject matter, wherein the circuit board has a clearance hole (16), and the clearance hole is aligned with one of the two first openings and one of the two second openings.

The electrical connector assembly according to one or more aspects of the above subject matter, wherein the base has a positioning hole (441), and the positioning hole is configured to mate a positioning pillar (P) of the housing of the amplifier.

The electrical connector assembly according to one or more aspects of the above subject matter, further comprising a grounding elastic component (50), wherein the grounding elastic component is disposed on the first joint and is configured to be in electrical contact with a housing (H) of the amplifier.

The electrical connector assembly according to one or more aspects of the above subject matter, wherein the grounding elastic component comprises a sleeve portion (51) and a plurality of elastic portions (52), the sleeve portion is sleeved on the first joint, the plurality of elastic portions are connected to the sleeve portion, and the plurality of elastic portions are arranged along a circumferential direction of the sleeve portion and are spaced apart from one another.

The aforementioned first electrical connector is configured to be electrically connected to an external component E (e.g., a cable), and the second electrical connector is configured to be electrically connected to a main board M in the amplifier.

Regarding to a joint assembly of a present amplifier, a receiving connector for receiving external signals is electrically connected to an internal signal transmission connector via a spring contact. This structural configuration is most suitable for the 1.2 GHz signal specified by DOCSIS 3.1, and its performance during 1.2 GHz signal transmission meet the requirements.

However, the aforementioned joint assembly does not perform well when used for the 1.8 GHz signal specified by DOCSIS 4.0. Therefore, researchers in this field are currently working to improve the structural configuration of the amplifier's joint assembly to ensure that it meets the required performance when used for the 1.8 GHz signal specified by DOCSIS 4.0.

Based on the aforementioned electrical connector assembly, by arranging the first electrical connector and second electrical connector on the circuit board, and having the first terminal of the first electrical connector electrically connected to the second terminal of the second electrical connector via the transmission circuit of the circuit board, this configuration enables the electrical connector assembly to meet the required performance when transmitting the 1.8 GHz signal specified by DOCSIS 4.0.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An electrical connector assembly (1), adapted for an amplifier, comprising:
a circuit board (10), having a transmission circuit (11);
a first electrical connector (20), disposed on the circuit board and comprising a first joint (21) and a first terminal (22), wherein the first terminal is disposed in the first joint; and
a second electrical connector (30), disposed on the circuit board and comprising a second joint (31) and a second terminal (32), wherein the second terminal is disposed in the second joint, and the first terminal is electrically connected to the second terminal via the transmission circuit.

2. The electrical connector assembly according to claim 1, wherein the first electrical connector and the second electrical connector are radio frequency coaxial connectors (e.g., a F-type connector and a G-type connector).

3. The electrical connector assembly according to claim 1, wherein the circuit board has a first surface (12), a second surface (13) and a side surface (14), the first surface and the second surface face away from each other, the side surface is connected to the first surface and the second surface, the transmission circuit is located at the first surface, the first joint of the first electrical connector is disposed on the side surface of the circuit board, the first terminal is in electrical contact with the transmission circuit on the first surface of the circuit board, the second joint of the second electrical connector is disposed on the second surface of the circuit board, the second terminal penetrates through the circuit board from the second surface of the circuit board and reaches the first surface to be in electrical contact with the transmission circuit.

4. The electrical connector assembly according to claim 1, wherein the first joint has an interior space (211) and two mount recesses (212), the first terminal is located in the interior space, the two mount recesses are respectively located two opposite sides of the interior space, and the circuit board is engaged with the two mount recesses and is partially located in the interior space.

5. The electrical connector assembly according to claim 1, wherein the circuit board has a notch (15) located at one corner of the circuit board, and the first electrical connector is located in the notch of the circuit board.

6. The electrical connector assembly according to claim 1, wherein a length (L) of the circuit board is not less than 15 mm and not greater than 60 mm, a width (W) of the circuit board is not less than 10 mm and not greater than 40 mm, and a thickness (T) of the circuit board is not less than 1 mm and not greater than 5 mm.

7. The electrical connector assembly according to claim 1, further comprising a casing 40), wherein the casing has an accommodation space (41), a first through hole (42) and a second through hole (43), the first through hole and the second through hole communicate with the accommodation space, the circuit board is disposed in the accommodation space of the casing, and the first joint and the second joint respectively penetrate through the first through hole and the second through hole.

8. The electrical connector assembly according to claim 7, wherein the casing comprises a base (44) and a cover (45) assembled with each other, the base and the cover together form the accommodation space, the base has two first openings (O1) communicating with the accommodation space, the cover has two second openings (O2) communicating with the accommodation space, the two first openings are respectively aligned with the two second openings, the two first openings and the second openings are respectively configured for two screws (S) to penetrate therethrough, such that the two screws fix the casing to a housing (H) of the amplifier.

9. The electrical connector assembly according to claim 8, wherein the circuit board has a clearance hole (16), and the clearance hole is aligned with one of the two first openings and one of the two second openings.

10. The electrical connector assembly according to claim 8, wherein the base has a positioning hole (441), and the positioning hole is configured to mate a positioning pillar (P) of the housing of the amplifier.

11. The electrical connector assembly according to claim 1, further comprising a grounding elastic component (50), wherein the grounding elastic component is disposed on the first joint and is configured to be in electrical contact with a housing (H) of the amplifier.

12. The electrical connector assembly according to claim 11, wherein the grounding elastic component comprises a sleeve portion (51) and a plurality of elastic portions (52), the sleeve portion is sleeved on the first joint, the plurality of elastic portions are connected to the sleeve portion, and the plurality of elastic portions are arranged along a circumferential direction of the sleeve portion and are spaced apart from one another.
